(19) United States
(12) Patent Application Publication
(10) Pub. No.: US 2007/0148298 A1
(43) Pub. Date: Jun. 28, 2007

(54) Method for producing baitang soup

(75) Inventors: Motokazu Nakayama, Tochigi (JP); Akihito Fujimoto, Ibaraki (JP); Makoto Watanabe, Yamaguchi (JP); Kenji Sato, Kyoto (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: KYOWA HAKKO FOOD SPECIALITIES CO., LTD., Tokyo (JP)

(21) Appl. No.: 10/584,259

(22) PCT Filed: Dec. 24, 2004
(86) PCT No.: PCT/JP04/19729

§ 371 Date: Jun. 26, 2006

(30) Foreign Application Priority Data
Dec. 26, 2003 (JP) 2003-432775

(51) Int. Cl. A23L 1/22

(52) U.S. Cl. 426/535

(57) ABSTRACT

An object of the present invention is to provide a method for producing bai tang soup with high emulsion stability and a method for improving the emulsion stability of baitang soup. In a method for producing baitang soup which comprises adding oil and fat to an aqueous phase obtained by separating an oily phase from a meat extract and mixing and emulsifying the mixture, baitang soup with improved emulsion stability can be provided by making the isoelectric point of 30 wt % or more of the proteins contained in the aqueous phase at least 1.5 lower than the pH of the baitang soup.

### TECHNICAL FIELD

The present invention relates to a method for producing bai tang soup and a method for improving the emulsion stability of baitang soup.

### BACKGROUND ART

Baitang soup is a generic name for meat extracts in an emulsified state, for example, the soup of “Tonkotsu Ramen” or Chinese noodle in pork bone soup.

When bai tang soup is produced on a small scale, as in the case of producing it at restaurants, usually, animal bone is heat-treated for a long time using an atmospheric cooker or the like under normal pressure conditions to extract a meat extract containing gelatin and oil and fat as main components, and the extract is naturally emulsified. However, a demand for industrially mass-produced baitang soup has been growing because the amount of waste such as bone is small and because it can be conveniently used.

When baitang soup is industrially produced, it is possible to use the method comprising heat treatment under normal pressure conditions as in the case of its production on a small scale. However, this method involves the problem that it takes a long time to produce it. Further, baitang soup produced under normal pressure conditions has the problem that its oil and fat content frequently varies according to production lot and complicated processes are required to prepare a homogeneous product.

On the other hand, when the extraction is carried out using a pressure cooker or the like under pressurized conditions, in addition to the advantage that heating time can be reduced, there is the advantage that because an oily phase and an aqueous phase are extracted from the raw material in a separated state, the content of oil and fat can be easily adjusted, facilitating preparation of a homogeneous product.

Accordingly, industrial production of baitang soup is often carried out by a method which comprises extracting meat extract under pressurized conditions; separating an oily phase from an aqueous phase in the obtained meat extract; and emulsifying the aqueous phase after adding an appropriate amount of oil and fat thereto. This method has, in addition to the advantage that the amount of oil and fat in baitang soup can be easily adjusted as mentioned above, the advantage that by concentrating the aqueous phase, it is possible to efficiently produce concentrated baitang soup. Concentrated baitang soup is much in demand because storage space and distribution costs can be reduced.

Whichever of the above methods is used for the production, however, when the prepared baitang soup is subjected to heat sterilization as it is, the problem is that the emulsion stability decreases with time.

Thus, for the purpose of improving the emulsion stability of baitang soup, starch, gelatin, polysaccharide thickeners, emulsifiers, etc. are usually added. However, addition of these substances may cause deterioration of the texture and taste and reduction of operability.

Also known is a method which comprises allowing two kinds of gelatin having different isoelectric points to be contained in the soup as an emulsifier (Japanese Published Unexamined Patent Application No. 3772/93). According to this method, it is necessary to previously provide two kinds of gelatin.

For these reasons, it is desired to develop a simple method for producing baitang soup having high emulsion stability.

### DISCLOSURE OF THE INVENTION

An object of the present invention is to provide a method for producing baitang soup having high emulsion stability and a method for improving the emulsion stability of baitang soup.

The present invention relates to the following (1) to (3).
(1) A method for producing baitang soup of the type wherein oil and fat is added to and mixed with an aqueous phase obtained by separating an oily phase from a meat extract and the mixture is emulsified, characterized in that the isoelectric point of 30 wt % or more of the proteins contained in the aqueous phase is made at least 1.5 lower than the pH of the baitang soup.
(2) The method according to claim 1, which further comprises concentrating the aqueous phase obtained by separating the oily phase from the meat extract.
(3) A method for improving the emulsion stability of baitang soup, which comprises making the isoelectric point of 30 wt % or more of the proteins contained in an aqueous phase of baitang soup at least 1.5 lower than the pH of the baitang soup.

The meat extract used in the present invention can be obtained as a liquid extract by adding an extraction medium to a raw material containing meat or bone of animals, heating the mixture and then subjecting the mixture to solid-liquid separation.

The animals may be any animal, and pig, chicken or cattle are suitably used. Any part of meat or bone of the animals may be used and they may be used either alone or as a mixture of two kinds or more.

Extraction from the raw material is carried out using an extraction medium such as an aqueous medium or an organic solvent, and an aqueous medium is preferably used.

Examples of the aqueous media include water and aqueous solutions of inorganic salts. Examples of the inorganic salts include sodium chloride, potassium chloride and calcium chloride.

As the organic solvent, ethanol is preferably used in view of the use for food and drink. Ethanol may be water-containing ethanol, and one with a moisture content of 10% (v/v) to 90% (v/v) is preferably used.

The extraction medium may have any pH, and preferably has a pH of 6 to 10 and more preferably a pH of 7 to 9.

For the extraction, any apparatus may be used so long as proteins, peptides and other taste elements can be extracted from the raw material under heating conditions. An example of the apparatus is a heating apparatus such as a pressure cooker.

Extraction is carried out by adding the extraction medium to the above-mentioned raw material and heating the mixture at 60 to 150° C., preferably 100 to 120° C., for 30 minutes to one week, preferably 30 minutes to 24 hours. It is preferred to release the generated vapor into the atmosphere during the heat treatment because this makes it easy to make the proportion of the proteins having an isoelectric point at least 1.5, preferably 1.5 to 4.0 lower than the pH of the baitang soup to be 30 wt % or more, preferably 40 wt % or more of the total proteins contained in the aqueous phase.

The heat treatment may be carried out by the combination of a treatment under normal pressure (0.1 MPa) conditions and that under pressurized conditions. For example, the heat treatment may be carried out by a method which comprises heating under pressurized conditions followed by heating under normal pressure.

The pressure for the heating under pressurized conditions is not specifically restricted, and is preferably 0.11 to 0.20 MPa (megapascal), more preferably 0.11 to 0.15 MPa and particularly preferably 0.11 to 0.13 MPa.

After the extraction operation, a liquid extract is obtained according to a solid-liquid separation method such as cake filtration, clarifying filtration, centrifugal filtration, a method using a filter press, sedimentation separation, centrifugal sedimentation or pressing separation. The thus obtained liquid extract can be used as a meat extract.

The obtained meat extract is allowed to stand still or subjected to centrifugation to separate into an upper layer and a lower layer, which are obtained as an oily phase and an aqueous phase, respectively.

Although the aqueous phase may be used as it is, for the production of bai tang soup, it is preferred to use it after concentration according to a method such as concentration by heating, concentration by freezing, reverse osmosis membrane concentration or vacuum concentration.

Taking the operability into consideration, concentration is carried out so that the solid content in the aqueous phase is preferably 10 to 50%, more preferably 20 to 40%, and further preferably 20 to 30%. When the content of gelatin in the aqueous phase is high, it is preferred to maintain the aqueous phase at a temperature higher than that at which gelatin does not gelate, for example, at 40° C. to 80° C.

The obtained aqueous phase is subjected to an isoelectric focusing apparatus such as Rotofor (manufactured by Bio-Rad) as it is or, if necessary, after dilution with water, etc. to fractionate the proteins in the aqueous phase according to their isoelectric point.

The amount of proteins in each of the fractions obtained by fractionation is measured, and the amount of the proteins is cumulatively added in order of increasing isoelectric point, thereby to find the amount of the proteins that are present in the aqueous phase and have an isoelectric point lower than a certain isoelectric point (designated as “A”).

The amount of proteins in all the fractions is cumulatively added to find the amount of the total proteins present in the aqueous phase (designated as “B”). By calculating the percentage of A to B, it is possible to find the proportion (%) of the proteins present in the aqueous phase and having an isoelectric point lower than a certain isoelectric point to the total proteins in the aqueous phase.

In finding the above “A” and “B”, each of the fractions obtained by fractionation according to the isoelectric point may be subjected to a method for quantitative determination of proteins such as Roley's method to measure the amount of proteins in each of the fractions, and the amount of proteins in each of the fractions may be cumulatively added in order of increasing isoelectric point. However, it is preferred to subject the fractions after the isoelectric focusing to sodium dodecyl sulfate polyacrylamide gel electrophoresis (SDS-PAGE) either directly or after isolating each of the fractions, calculate the amount of proteins constituting each band or spot on the gel after the SDS-PAGE from the density and the area of the band or spot, and cumulatively add the amount of proteins in order of increasing isoelectric point.

In this manner, it is possible to find the proportion (%) of the proteins having an isoelectric point at least 1.5, preferably 1.5 to 4.0 lower than the pH of bai tang soup to the total proteins in the aqueous phase.

The electrophoresis such as isoelectric focusing and SDS-PAGE and the quantitative determination of proteins can be carried out by known methods described, for example, in Shin Seikagaku Jikken Koza (New Biochemical Experiments) 1, Protein I, Edited by The Japanese Biochemical Society (1990). In each of the methods, conditions can be properly determined.

By using the above methods, an aqueous phase containing the proteins having an isoelectric point at least 1.5, preferably 1.5 to 4.0 lower than the pH of baitang soup in an amount of 30 wt % or more, preferably 40 wt % or more of the total proteins can be prepared. When the proportion of the proteins having an isoelectric point at least 1.5 lower than the pH of baitang soup in the prepared aqueous phase is less than 30 wt % of the total proteins, an aqueous phase meeting the condition may be prepared by further subjecting the aqueous phase to heat treatment at 60 to 150° C., preferably 100 to 120° C., for 30 minutes to one week, preferably 30 minutes to 24 hours, or by adding a protein having an isoelectric point at least 1.5 lower than the pH of bai tang soup to the aqueous phase.

In the latter method comprising the addition of a protein, any protein having an isoelectric point at least 1.5 lower than the pH of baitang soup may be used, and an example of the protein is casein.

Further, it is possible to separately prepare a meat extract in which the proportion of the proteins having an isoelectric point at least 1.5 lower than the pH of baitang soup to the total proteins is 30 wt % or more, preferably 40 wt % or more according to the above-described method and add the meat extract or an aqueous phase obtained from the meat extract to the above aqueous phase. In this case, it is preferred to measure the isoelectric point of the proteins in the aqueous phase of the meat extract according to the above method and determine the amount of addition before adding it.

In addition to the above-described methods, a method comprising adjustment of the pH of the aqueous phase is mentioned as a method of adjustment to fulfill the above condition. For example, the pH of the aqueous phase is adjusted using an alkali which can be used for food and drink such as sodium hydroxide so that the isoelectric point of 30 wt % or more, preferably 40 wt % or more of the total proteins is at least 1.5, preferably 1.5 to 4.0 lower than the pH of bai tang soup.

In the above-described methods, as the pH of the aqueous phase and that of baitang soup are usually almost the same, it is convenient to use the pH of the aqueous phase as a measure of the pH of baitang soup to prepare the aqueous phase.

To the aqueous phase obtained above is added oil and fat, followed by mixing, and the mixture of the aqueous phase and the oil and fat is emulsified using an apparatus such as stirring-type homomixer, high pressure homogenizer, rotary colloid mill, ultrasonicator or votator, preferably stirring-type homomixer or high pressure homogenizer. The obtained emulsion can be used as the baitang soup of the present invention.

Examples of the oil and fat include animal oils and fats such as bone oil, lard, chicken oil, beef tallow and milk fat and vegetable oils and fats such as rapeseed oil, soybean oil, palm oil, corn oil, rice bran oil, palm kernel oil, safflower oil, sesame oil and cottonseed oil, and bone oil is preferably used.

Further, the oily phase obtained by separating the aqueous phase from the meat extract can be used as the oil and fat.

In carrying out the emulsification by adding oil and fat to the aqueous phase, although the amount of the oil and fat to be added is not particularly limited, it is preferred to add the oil and fat so that its concentration in the baitang soup is 0.5 to 60% (v/v), preferably 10 to 40% (v/v).

The emulsification may be carried out under any conditions so long as a mixture of the aqueous phase and the oil and fat can be emulsified, and the conditions vary depending upon the apparatus used. For example, the emulsification is carried out at 1,000 to 10,000 r.p.m. for 10 minutes to 8 hours in the case of a stirring-type homomixer and at a pressure of 10 to 40 MPa for 10 minutes to 8 hours in the case of a high pressure homogenizer, with the temperature of the mixture of the aqueous phase and the oil and fat being kept at 40° C. to 100° C., preferably 50° C. to 80° C.

The baitang soup of the present invention may contain various additives which can be used for food and drink, such as inorganic salts, acids, amino acids, nucleic acids, sugars, seasonings and spices, according to need.

Examples of the inorganic salts include sodium chloride, potassium chloride and ammonium chloride. Examples of the acids include ascorbic acid, fumaric acid, malic acid, tartaric acid, citric acid, lactic acid, acetic acid and carboxylic acids such as fatty acid, and salts thereof. Examples of the salts include sodium salt and potassium salt. Examples of the amino acids include sodium glutamate and glycine. Examples of the nucleic acids include sodium inosinate and sodium guanylate. Examples of the sugars include sucrose, glucose, lactose and fructose. Examples of the seasonings include soy sauce, miso (fermented soybean paste) and natural seasonings such as extracts of vegetables and fishes and shellfishes, and the spices include various spices. The amount of these additives used may be properly determined according to the purpose of use. For example, they can be used in an amount of 0.1 to 100 parts by weight per 100 parts by weight of the mixture of the aqueous phase and the oil and fat.

The pH of the baitang soup of the present invention is not particularly limited and is preferably 6.0 to 9.0, more preferably 6.0 to 8.0.

The obtained baitang soup may be packed in a container as it is, but is preferably subjected to heat sterilization such as retort sterilization before packing in a container.

As for the baitang soup obtained by separating a meat extract into an aqueous phase and an oily phase, adding oil and fat to the aqueous phase and mixing and emulsifying the mixture as described above, the emulsion stability of the baitang soup can be improved by making the isoelectric point of 30 wt % or more, preferably 40 wt % or more of the total proteins in the aqueous phase at least 1.5, preferably 1.5 to 4.0 lower than the pH of the baitang soup.

It is also possible to improve the storage stability of conventional baitang soup such as commercially available baitang soup. In this case, the aqueous phase of the baitang soup can be obtained, for example, by separating the baitang soup into aqueous phase and oily phase by centrifugation or the like. The isoelectric point of the proteins in the aqueous phase can be examined in the above-described manner. When the proportion of the proteins having an isoelectric point at least 1.5 lower than the pH of the baitang soup is less than 30 wt % of the total proteins in the aqueous phase, the emulsion stability of the baitang soup can be improved by preparing baitang soup according to the above-described method so that the proportion of the proteins having an isoelectric point at least 1.5, preferably 1.5 to 4.0 lower than the pH of the baitang soup to the total proteins in the aqueous phase is 30 wt % or more, preferably 40 wt % or more. The method may be any of the above-described methods including heating of the aqueous phase, adjustment of the pH of the aqueous phase and addition of a protein having an isoelectric point at least 1.5 lower than the pH of the baitang soup.

The emulsion stability of baitang soup can be examined, for example, by a method in which baitang soup is subjected to heat treatment under the conditions of retort sterilization and the state of emulsification is observed after allowing the resulting soup to stand, and a method in which turbidity is measured before and after heat sterilization using a spectrophotometer, etc. and the emulsion stability is examined by comparing the turbidities [Saishin Nyukagijutsu Handobukku (Latest Emulsification Technology Handbook), Kogyo Gijutsu Kai (1986), p. 183-199; Shokuhin-yo Nyukazai (Emulsifiers for Foods), 2nd Edition, Saiwai Shobo (1991), p. 91-92].

An example of the present invention is shown below.

### BEST MODES FOR CARRYING OUT THE INVENTION

### EXAMPLE 1

(1) Pork bone (40 kg) and 80 kg of tap water were placed in a pressure extractor (Komatsugawa Chemical Engineering Co., Ltd., the same applies hereunder) and subjected to heat and pressurization treatment (0.12 to 0.13 MPa, the same applies hereunder) at 120° C. for 120 minutes. After the heat and pressurization treatment, the mixture was kept at 95° C. overnight with the lid open, during which the liquid amount of the contents of the extractor was adjusted to 80 kg by adding water.

The contents of the pressure extractor were taken out and allowed to stand still to separate into an upper layer and a lower layer, and then the lower layer was drawn to be recovered. The lower layer was filtered through oil filter paper to remove solid materials such as bone, whereby a liquid extract having a solid content of 5.5% was obtained. The liquid extract was concentrated using an evaporator to prepare about 14.5 kg of a liquid extract of pH 6.3 having a solid content of 30%. The extract was designated as aqueous phase 1.

Aqueous phase 1 was diluted 100-fold with water, and 50 ml of the obtained diluted solution was subjected to Rotofor (manufactured by Bio-Rad), an isoelectric focusing apparatus, under the condition of 12 W for 2 hours to fractionate proteins into 20 fractions according to their isoelectric point.

Each of the fractions was subjected to SDS-PAGE (Mini-PROTEAN 3 Ready Gel Cell, manufactured by Bio-Rad) using 12.5% acrylamide gel (Ready Gel J, manufactured by Bio-Rad) at 20 mA for about one hour. After the electrophoresis, the acrylamide gel was stained with a solution comprising 450 ml of water, 450 ml of methanol, 100 ml of acetic acid and 2.5 g of Coomassie Brilliant Blue for about 15 minutes, followed by decolorization treatment with a solution comprising 20% (v/v) 2-propanol and 10% (v/v) acetic acid for about 5 hours. After the decolorization treatment, the gel was read using a scanner (Master Scan, manufactured by SS Machine Co., Ltd.), and the density and the area of bands were measured to calculate the relative value of the amount of proteins in each fraction, which was regarded as the relative value of the amount of proteins at each isoelectric point. A graph with the abscissa indicating the isoelectric point and the ordinate indicating the relative value of the amount of proteins at each isoelectric point was prepared, and a distribution map of proteins in which isoelectric point was used as an index was prepared by connecting the plot points with a smooth curve.

Aqueous phase 1 (1 kg) and 0.43 kg of pork bone oil (manufactured by Zenmi Shokuhin Co., Ltd., the same applies hereunder) were charged in TK Homomixer (manufactured by Tokushu Kika Kogyo Co., Ltd., the same applies hereunder) and subjected to emulsification treatment at 10,000 r.p.m. for 10 minutes to obtain baitang soup of pH 6.3. The baitang soup was designated as baitang soup 1.

In the distribution map prepared above, the area of the region formed by the curve and the abscissa of the graph was measured, which was regarded as the total amount of proteins. Further, of the region, the area of the section in which the value of the abscissa is 4.8 or less, which is at least 1.5 lower than the pH of the baitang soup (pH 6.3), was measured. This was regarded as the amount of the proteins having an isoelectric point at least 1.5 lower than the pH of baitang soup 1 (pH 6.3) in aqueous phase 1.

Based on the above, the proportion of the proteins having an isoelectric point at least 1.5 lower than the pH of baitang soup 1 (pH 6.3) to the total proteins in aqueous phase 1 was calculated. As a result, the proportion was 40 wt %.

Baitang soup 1 was placed in a 500-ml retort pouch and subjected to retort sterilization at 121° C. for 30 minutes.
(2) Aqueous phase 4 prepared in (4) below was adjusted to pH 7.5 with sodium hydroxide to prepare aqueous phase 2. Aqueous phase 2 (1 kg) and 0.43 kg of pork bone oil were charged in TK Homomixer and subjected to emulsification treatment at 10,000 r.p.m. for 10 minutes to prepare baitang soup of pH 7.5. The baitang soup was designated as baitang soup 2.

Distribution of the isoelectric point and the proportion of the proteins contained in aqueous phase 2 was examined in accordance with the method described in the above (1). As a result, it was found that the proteins having an isoelectric point of 6.0 or less, which is at least 1.5 lower than the pH of baitang soup 2 (pH 7.5), comprise 40 wt % of the total proteins in aqueous phase 2.

Baitang soup 2 was placed in a 500-ml retort pouch and subjected to retort sterilization at 121° C. for 30 minutes.
(3) Pork bone (7.7 kg) and 20 kg of tap water adjusted to pH 9.0 with sodium hydroxide were placed in a pressure extractor and subjected to heat and pressurization treatment at 120° C. for 60 minutes. After the heat and pressurization treatment, the mixture was allowed to boil for 8 hours with the lid of the heat extractor open. The contents of the pressure extractor were taken out and allowed to stand still to separate into an upper layer and a lower layer, and then the lower layer was drawn to be recovered. The lower layer was filtered through oil filter paper to remove solid materials such as bone, whereby a liquid extract having a solid content of 6.2% was obtained. The liquid extract was concentrated using an evaporator to prepare about 16 kg of a liquid extract of pH 6.8 having a solid content of 30%. The extract was designated as aqueous phase 3.

By examining distribution of the isoelectric point and the proportion of the proteins contained in aqueous phase 3 in accordance with the method described in the above (1), it was found that the proteins having an isoelectric point of 5.3 or less, which is at least 1.5 lower than the pH of aqueous phase 3 (pH 6.8), comprise 40 wt % of the total proteins in aqueous phase 3.

Aqueous phase 4 (500 g) prepared in (4) below and 1000 g of aqueous phase 3 were mixed to prepare a mixture of aqueous phase 3 and aqueous phase 4, which was designated as aqueous phase 5.

Aqueous phase 5 (1 kg) and 0.43 kg of pork bone oil were charged in TK Homomixer and preemulsified at 10,000 r.p.m. for 10 minutes, followed by treatment using a high pressure homogenizer at a pressure of 39.2 MPa to prepare bai tang soup 3.

By examining distribution of the isoelectric point and the proportion of the proteins contained in aqueous phase 5 in accordance with the method described in the above (1), it was found that the proteins having an isoelectric point of 5.3 or less, which is at least 1.5 lower than the pH of baitang soup 3 (pH 6.8), comprise 30 wt % of the total proteins in aqueous phase 5.

Bai tang soup 3 was placed in a 500-ml retort pouch and subjected to retort sterilization at 121° C. for 30 minutes.
(4) Pork bone (40 kg) and 80 kg of tap water were placed in a pressure extractor and subjected to heat and pressurization treatment at 120° C. for 120 minutes. After the heat and pressurization treatment, the pressure extractor was naturally cooled and allowed to stand overnight with the lid closed.

The contents of the pressure extractor were taken out and allowed to stand still to separate into an upper layer and a lower layer, and then the lower layer was drawn to be recovered. The lower layer was filtered through oil filter paper to remove solid materials such as bone, whereby a liquid extract having a solid content of 6.0% was obtained. The liquid extract was concentrated using an evaporator to prepare about 16 kg of a liquid extract of pH 6.8 having a solid content of 30%. The extract was designated as aqueous phase 4.

By examining distribution of the isoelectric point and the proportion of the proteins contained in aqueous phase 4 in accordance with the method described in the above (1), it was found that the proteins having an isoelectric point of 5.3 or less, which is at least 1.5 lower than the pH of aqueous phase 4 (pH 6.8), comprise 10 wt % of the total proteins in aqueous phase 4.

Aqueous phase 4 (1 kg) and 0.43 kg of pork bone oil were mixed, charged in TK Homogenizer and subjected to emulsification treatment at 10,000 r.p.m. for 10 minutes to obtain baitang soup of pH 6.8. The baitang soup was designated as baitang soup 4.

Baitang soup 4 was placed in a 500-ml retort pouch and subjected to retort sterilization at 121° C. for 30 minutes.
(5) Baitang soups 1 to 4 before and after the retort sterilization prepared in the above (1) to (4) were diluted 1000-fold with water and the absorbance at 660 nm was measured using a spectrophotometer. The absorbance (OD₆₆₀) of the soups before retort sterilization was designated as A and OD₆₆₀ of the soups after retort sterilization was designated as B.

The value obtained according to the following equation was regarded as the value showing the emulsion stability of baitang soup (hereinafter referred to as “rate of emulsion stability”).
Rate of emulsion stability (%)=B/A×100
(6) Each of the baitang soups after retort sterilization was allowed to stand for one month as packaged in a retort pouch. After one month, the pouch was opened and the emulsification state of baitang soup was examined.

Table 1 shows the pH, the proportion of the proteins having an isoelectric point at least 1.5 lower than the pH of the baitang soup in the aqueous phase of the baitang soup, the rate of emulsion stability and the emulsification state after one month with respect to each baitang soup.

TABLE 1

| | | Proportion of | | |
|---|---|---|---|---|
| | | proteins having | | |
| | | isoelectric | | |
| | | point at least | | |
| | | 1.5 lower than | Rate of | |
| | pH of | the pH of | emulsion | |
| Baitang | baitang | baitang soup | stability | State after |
| soup | soup | (%) | (%) | one month |
| 1 | 6.3 | 40 | 91.2 | Good |
| | | | | emulsification |
| | | | | state |
| 2 | 7.5 | 40 | 87.5 | Good |
| | | | | emulsification |
| | | | | state |
| 3 | 6.8 | 30 | 75.0 | Good |
| | | | | emulsification |
| | | | | state with |
| | | | | some creaming |
| 4 | 6.8 | 10 | 50.5 | Separation of |
| | | | | oily phase |

As shown in Table 1, baitang soups 1 to 3 which contain the proteins having an isoelectric point at least 1.5 lower than the pH of the baitang soup in an amount of 30 wt % or more of the total proteins in the aqueous phase showed good emulsion stability.

### INDUSTRIAL APPLICABILITY

According to the present invention, a method for producing baitang soup with high emulsion stability and a method for improving the emulsion stability of baitang soup can be provided.

1. (canceled)

2. The method according to claim 4, which further comprises concentrating the aqueous phase obtained by separating the oily phase from the meat extract.

3. A method for improving the emulsion stability of baitang soup, which comprises making the isoelectric point of 30 wt % or more of the proteins contained in an aqueous phase of baitang soup at least 1.5 lower than the pH of the baitang soup.

4. A method for producing baitang soup which comprises:
separating an oily phase from a meat extract;
adding oil and fat to the resulting aqueous phase to obtain a mixture; and
mixing and emulsifying the mixture to prepare the baitang soup,
wherein the isoelectric point of 30 wt % or more of the proteins contained in the aqueous phase is made at least 1.5 lower than the pH of the baitang soup.
